(19) United States
(12) Patent Application Publication
(10) Pub. No.: US 2008/0170347 A1
(43) Pub. Date: Jul. 17, 2008

(54) Apparatus for Switching a Cook Top and Method for Assessing Faulty Operation of a Cook Top

(75) Inventor: Georg Arnold, Schwabach (DE)

Correspondence Address: LERNER GREENBERG STEMER LLP, P O BOX 2480, HOLLYWOOD, FL, 33022-2480, US

(73) Assignee: Diehl AKO Stiftung & Co. KG, Wangen (DE)

(21) Appl. No.: 12/013,490

(22) Filed: Jan. 14, 2008

(30) Foreign Application Priority Data
Jan. 13, 2007 (DE) 10 2007 002 060.2

(51) Int. Cl. H01H 47/00

(52) U.S. Cl. 361/170

(57) ABSTRACT

An apparatus for switching a cook top having at least one cooking area, includes a clocking relay for clocking operation of a heating device of a cooking area, a control device for driving the clocking relay, a relay coil current measurement device for measuring the current through a relay coil of the clocking relay, and an evaluation device for assessing faulty operation of the cook top on the basis of the current through the relay coil of the clocking relay, as measured by the relay coil current measurement device. A method for assessing faulty operation of a cook top having at least one cooking area, is also provided.

### CROSS-REFERENCE TO RELATED APPLICATION

This application claims the priority, under 35 U.S.C. §119, of German Patent Application DE 10 2007 002 060.2, filed Jan. 13, 2007; the prior application is herewith incorporated by reference in its entirety.

### BACKGROUND OF THE INVENTION

### Field of the Invention

The present invention relates to an apparatus for switching a cook top having at least one cooking area, including a clocking relay for clocking operation of a heating device of a cooking area, and a control device for driving the clocking relay. The present invention also relates to an apparatus for switching a cook top having at least one cooking area, including a clocking relay for clocking the operation of a heating device of a cooking area, a phase isolating relay for isolating the heating device of the cooking area from the voltage supply, and a control device for driving the clocking relay and the phase isolating relay. The invention furthermore relates to a method for assessing faulty operation of a cook top having at least one cooking area, including a clocking relay for clocking the operation of a heating device for the cooking area, and a control device for driving the clocking relay. The invention additionally relates to a method for assessing faulty operation of a cook top having at least one cooking area, including a clocking relay for clocking the operation of a heating device for the cooking area, a phase isolating relay for isolating the heating device of the cooking area from the voltage supply, and a control device for driving the clocking relay and the phase isolating relay.

The electrical heating devices for cooking areas on a cook top or cool top platform are normally each switched through a clocking relay, in order to operate the heating devices at a desired heating power level in the clocked mode. It is also conventional to use a phase isolating relay for simultaneous isolation of a plurality of heating devices from the operating voltage.

In order to avoid a fault resulting from sticking of the relay contacts or in the drive in such relay drives, a second relay contact of an additional relay is frequently also provided, for safety. That method is subject to the problem that a fault in the drive for the relay or sticking of the relay contact cannot be identified in some cases since they need not necessarily lead immediately to a noticeable malfunction at that stage. If a further fault then occurs, that results in a malfunction which in some circumstances can no longer be switched off.

### SUMMARY OF THE INVENTION

It is accordingly an object of the invention to provide an apparatus for switching a cook top having at least one cooking area, in which the apparatus can reliably assess faulty operation of the cook top, as well as a method for safe assessment of faulty operation of a cook top having at least one cooking area, which overcome the hereinafore-mentioned disadvantages of the heretofore-known apparatuses and methods of this general type.

With the foregoing and other objects in view there is provided, in accordance with the invention, an apparatus for switching a cook top having at least one cooking area with a heating device. The apparatus comprises a clocking relay for clocking operation of the heating device of a cooking area. The clocking relay has a relay coil. A relay coil current measurement device measures current through the relay coil of the clocking relay. A control and evaluation device drives the clocking relay and assesses faulty operation of the cook top on the basis of the current through the relay coil of the clocking relay, as measured by the relay coil current measurement device.

In order to assess faulty operation of a cook top having at least one cooking area, an apparatus such as this can be used to measure a current through a relay coil of the clocking relay, with faulty operation of the cook top being assessed on the basis of the measured current through the relay coil of the clocking relay.

This method represents a particularly simple and thus low-cost option for assessing faulty operation of a cook top having at least one cooking area. In particular, faulty driving of the clocking relay should be mentioned herein as one possible type of faulty operation of the cook top.

In accordance with another feature of the invention, the relay coil current measurement device is preferably provided in a drive path of the clocking relay.

The expression “a clocking relay” means a mechanical relay, an electronic relay or an electronic circuit breaker.

With the objects of the invention in view, there is also provided an apparatus for switching a cook top having at least one cooking area with a heating device. The apparatus comprises a clocking relay for clocking operation of the heating device of a cooking area. A phase isolating relay isolates the heating device of the cooking area from a voltage supply. A load-current measurement device measures current through the heating device of the cooking area. A control and evaluation device drives the clocking relay and the phase isolating relay and assesses faulty operation of the cook top on the basis of the current through the heating device, as measured by the load-current measurement device.

In order to assess faulty operation of the cook top, an apparatus such as this can be used to measure a current through the heating device for the cooking area, with faulty operation of the cook top being assessed on the basis of the measured current through the heating device.

As an alternative to current measurement, it is possible to measure the voltage applied to the load.

In addition to detection of a faulty drive of the clocking relay as in the first embodiment, this apparatus can also be used to detect faults in the clocking relay itself (for example stuck relay contacts). Furthermore, this apparatus also makes it possible to identify what load is being applied to the individual paths so that the electronics can automatically be set to different load conditions and can prevent overloading of individual phases. It is also possible to ensure a maximum current load.

In accordance with another feature of the invention, the load-current measurement device is preferably provided in an operating-current line for the heating device.

In accordance with a further feature of the invention, the cook top has a plurality of heating devices for a plurality of cooking areas, the phase isolating relay is used to isolate all of the heating devices in a group of heating devices for the cooking areas from the voltage supply, a current is measured in a common operating-current line for all of the heating devices in the group of heating devices, and faulty operation of the cook top is assessed on the basis of the measured current in the common operating-current line.

It is, of course, also possible to combine the first and second embodiments, as described above, with one another in any desired manner.

With the objects of the invention in view, there is furthermore provided a method for assessing faulty operation of a cook top having at least one cooking area with a heating device. The method comprises clocking operation of the heating device for the cooking area with a clocking relay having a relay coil, driving the clocking relay with a control device, measuring a current through the relay coil of the clocking relay, and assessing faulty operation of the cook top on the basis of the measured current through the relay coil of the clocking relay.

With the objects of the invention in view, there is concomitantly provided a method for assessing faulty operation of a cook top having at least one cooking area with a heating device. The method comprises clocking operation of the heating device for the cooking area with a clocking relay, isolating the heating device of the cooking area from a voltage supply with a phase isolating relay, driving the clocking relay and the phase isolating relay with a control device, measuring a current through the heating device for the cooking area, and assessing faulty operation of the cook top on the basis of the measured current through the heating device.

The invention described above makes it possible to detect faults which have already occurred in a relay control for a cook top without this resulting in a malfunction of the cook top or a critical state. The operational safety of the cook top can therefore be improved.

Other features which are considered as characteristic for the invention are set forth in the appended claims.

Although the invention is illustrated and described herein as embodied in an apparatus for switching a cook top and a method for assessing faulty operation of a cook top, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a simplified schematic and block diagram of a control system for a cook top having a plurality of cooking areas, according to a first exemplary embodiment of the invention; and

FIG. 2 is a simplified schematic and block diagram of a control system for a cook top having a plurality of cooking areas, according to a second exemplary embodiment of the invention.

### DETAILED DESCRIPTION OF THE INVENTION

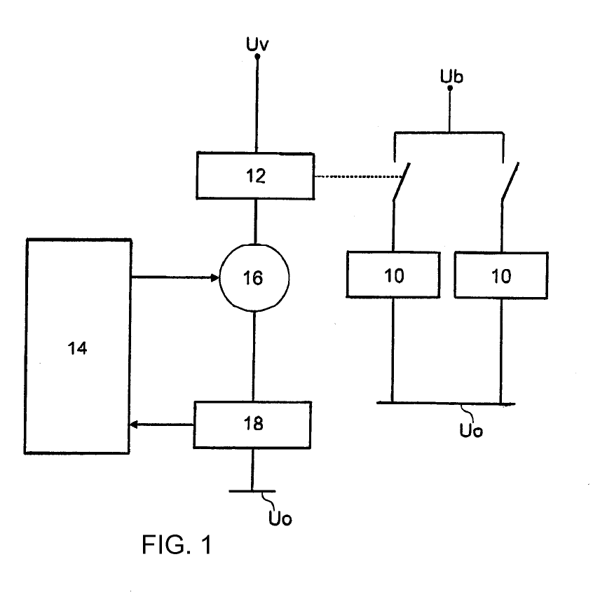

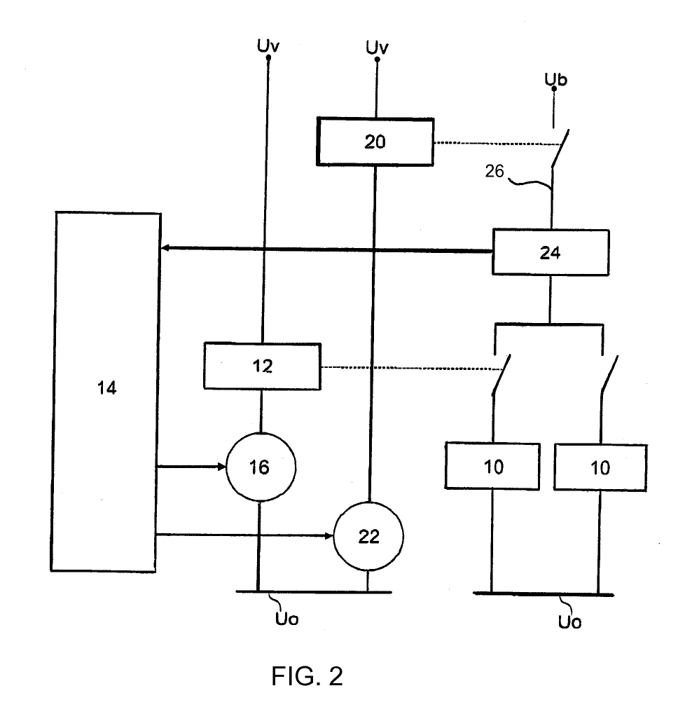

The present invention will now be explained in more detail by using two preferred exemplary embodiments and by reference to FIG. 1 and FIG. 2, respectively. In this case, identical or similar components in the two exemplary embodiments are provided with the same reference numerals, and the descriptions of components such as these will not unnecessarily be repeated.

Referring now to the figures of the drawings in detail and first, particularly, to FIG. 1 thereof, there is seen a highly simplified schematic and block diagram of a drive for a cook top according to the first preferred exemplary embodiment of the present invention. The cook top in this case has two cooking areas, each having an electrical heating device 10. However, the invention can, of course, also be applied analogously to other cook tops having different numbers of cooking areas.

The electrical heating devices 10 are each connected to a voltage supply which is formed by an operating voltage Ub and a neutral conductor Uo. Each heating device 10 is operated by a clocking relay 12, clocked with a desired heating power. The clocking relay 12 is in turn driven by a control system 14, which is the control and evaluation device of the invention, through a drive element 16. A drive path of the clocking relay 12 is connected between a supply voltage Uv and the neutral conductor Uo.

In the exemplary embodiment shown in FIG. 1, a relay coil current measurement device 18 is also provided in the drive path of the clocking relay 12, for detecting the current through the relay coil of the clocking relay 12, and passing the measurement signal to the control system 14. The control system 14 can then assess faults which relate to the drive path.

Although not illustrated in FIG. 1 for the sake of simplicity, a dedicated clocking relay 12 having its own drive path is, of course, provided for each electrical heating device 10 in the cook top, and they are all driven and monitored by the control system 14.

This very simple and therefore low-cost construction of the overall control apparatus 12-18 with a small number of additional components allows faulty operation of the cook top to be assessed in a simple manner on the basis of the current, as measured by the relay coil current measurement device 18, through the relay coil of the clocking relay 12. In this case, in particular, a fault in the drive for the clocking relay 12 can be detected as faulty operation of the cook top.

As an alternative to a mechanical relay as the clocking relay 12, it is possible to use an electronic relay or an electronic circuit breaker, such as a triac or an IGBT.

FIG. 2 shows a highly simplified schematic and block diagram of a drive for a cook top according to the second preferred exemplary embodiment of the present invention. The cook top has two cooking areas in this case as well, each with an electrical heating device 10.

In addition to the control circuit for the electrical heating devices 10 in the first exemplary embodiment, this control circuit in FIG. 2 has a phase isolating relay 20, which can isolate all of the heating devices 10 or all of the heating devices 10 in a group of heating devices from the voltage supply, that is to say from the operating voltage Ub or from the neutral conductor Uo. The phase isolating relay 20 is likewise driven by the control system 14 through an appropriate drive element 22.

In addition, a load-current measurement device 24 is disposed in a common operating-current line 26, in order to detect the current through all of the heating devices 10 or all of the heating devices 10 in a group of heating devices. A measurement signal produced by the load-current measurement device 24 is supplied to the control system 14 for evaluation, and this can then assess faulty operation of the cook top on the basis of the current through the heating devices 10.

In contrast to the first exemplary embodiment described above, in addition to detection of a faulty drive for the clocking relay 12 (when the phase isolating relay 20 is connected), a fault in the clocking relay 12 or in the phase isolating relay 20 itself (for example sticking or jammed contact points) can also be detected in this case as faulty operation of the cooking area. When a cooking area is being operated correctly, this must result in an appropriate current flow in the operating-current line 26 when both relays 12, 20 are switched on.

Furthermore, in this exemplary embodiment, the control system 14 can also tell what load is being applied to the individual paths, that is to say the individual groups of heating devices 10. This means that it is possible for the electronics to be able to automatically set different variants and load conditions. For example, this makes it possible to avoid overloading of individual phases.

In addition, a maximum current load can be ensured in the common operating-current line 26. The control system 14 can use the measurement signal from the load-current measurement device 24 to tell, for example, that two major loads 10 have already been switched on, and can now prevent a further load 10 from being connected at the same time. If only relatively small loads 10 have been switched on, then the control system 14 can allow further loads to be connected.

Although the present invention has been described entirely on the basis of two preferred exemplary embodiments, it is clear to a person skilled in the art that various changes and modifications can be made without departing from the scope of protection defined in the claims.

For example, the two exemplary embodiments of FIG. 1 and FIG. 2, as described above, can also be combined with one another as required. For example, it is thus feasible to additionally provide the relay coil current measurement device 18 from the first exemplary embodiment in the drive path of the clocking relay 12 in the control circuit for the second exemplary embodiment, and for its measurement signal to be evaluated in a corresponding manner by the control system 14.

Furthermore, in the above-described exemplary embodiments, the relay coil current and/or the load-current have each been measured and evaluated during operation of the cooking area. Alternatively, it is also possible to drive the relays 12, 20 in an appropriate test mode in order to allow any faults to be detected.

Although the invention has been explained by using the example of a cook top having a plurality of cooking areas, the present invention can also be transferred analogously to control apparatuses for other electronic domestic appliances having a plurality of loads, for example cooking ovens, washing machines, etc.

1. An apparatus for switching a cook top having at least one cooking area with a heating device, the apparatus comprising:
a clocking relay for clocking operation of the heating device of a cooking area, said clocking relay having a relay coil;
a relay coil current measurement device for measuring current through said relay coil of said clocking relay; and
a control and evaluation device for driving the clocking relay and assessing faulty operation of the cook top on the basis of the current through said relay coil of said clocking relay, as measured by said relay coil current measurement device.

2. The apparatus according to claim 1, wherein said relay coil current measurement device is provided in a drive path of said clocking relay.

3. An apparatus for switching a cook top having at least one cooking area with a heating device, the apparatus comprising:
a clocking relay for clocking operation of the heating device of a cooking area;
a phase isolating relay for isolating the heating device of the cooking area from a voltage supply;
a load-current measurement device for measuring current through the heating device of the cooking area; and
a control and evaluation device for driving said clocking relay and said phase isolating relay and for assessing faulty operation of the cook top on the basis of the current through the heating device, as measured by the load-current measurement device.

4. The apparatus according to claim 3, wherein said load-current measurement device is provided in an operating-current line of the heating device.

5. The apparatus according to claim 3, wherein:
the at least one cooking area with a heating device is a plurality of cooking areas with a plurality of heating devices in a group of heating devices;
said phase isolating relay is provided for isolating all of the heating devices in the group of heating devices for the cooking areas from the voltage supply; and
said load-current measurement device is provided in a common operating-current line for all of the heating devices in the group of heating devices.

6. The apparatus according to claim 3, which further comprises:
a relay coil current measurement device for measuring the current through a relay coil of said clocking relay;
said evaluation device also assessing faulty operation of the cook top on the basis of current through said relay coil of said clocking relay, as measured by said relay coil current measurement device.

7. The apparatus according to claim 6, wherein said relay coil current measurement device is provided in a drive path of said clocking relay.

8. A method for assessing faulty operation of a cook top having at least one cooking area with a heating device, the method comprising the following steps:
clocking operation of the heating device for the cooking area with a clocking relay having a relay coil;
driving the clocking relay with a control device;
measuring a current through the relay coil of the clocking relay; and
assessing faulty operation of the cook top on the basis of the measured current through the relay coil of the clocking relay.

9. A method for assessing faulty operation of a cook top having at least one cooking area with a heating device, the method comprising the following steps:
clocking operation of the heating device for the cooking area with a clocking relay;
isolating the heating device of the cooking area from a voltage supply with a phase isolating relay;
driving the clocking relay and the phase isolating relay with a control device;
measuring a current through the heating device for the cooking area; and
assessing faulty operation of the cook top on the basis of the measured current through the heating device.

10. The method according to claim 9, which further comprises:
providing the at least one cooking area with a heating device as a plurality of cooking areas with a plurality of heating devices in a group of heating devices;
carrying out the isolating step by isolating all of the heating devices in the group of heating devices for the cooking areas from the voltage supply with the phase isolating relay;
carrying out the measuring step by measuring a current in a common operating-current line for all of the heating devices in the group of heating devices; and
carrying out the assessing step by assessing faulty operation of the cook top on the basis of the measured current in the common operating-current line.

11. The method according to claim 9, which further comprises measuring a current through a relay coil of the clocking relay, and assessing faulty operation of the cook top on the basis of the measured current through the relay coil of the clocking relay.
